(19) United States
(12) Patent Application Publication
(10) Pub. No.: US 2007/0204515 A1
(43) Pub. Date: Sep. 6, 2007

(54) Brake device for garage doors and the like, kit for assembling the same, and door assembly provided with the brake device

(75) Inventors: Patrick Barriault, Drummondville (CA); Dominic Courville, Saint-Jean-sur-Richelieu (CA); Michel Beaudoin, Drummondville (CA)

Correspondence Address: MERCHANT & GOULD PC, P.O. BOX 2903, MINNEAPOLIS, MN, 55402-0903, US

(73) Assignee: CANIMEX INC., Drummondville (CA)

(21) Appl. No.: 11/702,774

(22) Filed: Feb. 6, 2007

Related U.S. Application Data
(60) Provisional application No. 60/765,165, filed on Feb. 6, 2006.
(60) Provisional application No. 60/873,965, filed on Dec. 11, 2006.

(51) Int. Cl. E05D 13/00

(52) U.S. Cl. 49/322

(57) ABSTRACT

A braking device configured for use with the counterbalancing system of a garage door. The brake device includes a support bracket, a ratchet wheel, a pawl arm, and a biasing spring. The support bracket is rigidly connected to a fixed structure and has a guiding slot. The ratchet wheel is securely mounted about the overhead shaft of the counterbalancing system and has at least one notch. The pawl arm has first and second ends, the first end of the pawl arm being pivotally connected to the support bracket and the second end of the pawl arm cooperating with the guiding slot and being movable with respect to the support bracket along said guiding slot. The first and second ends of the pawl arm are further connected to flanges of a plug on either side of the overhead shaft. The biasing spring is operatively connected between the support bracket and the pawl arm so as to exert a biasing force for biasing the pawl arm towards the ratchet wheel. The pawl arm is devised so that, an element thereof is adjacent to the ratchet wheel, said element being shaped and sized to be removably insertable into at least one notch of the ratchet wheel so as to block rotation of the ratchet wheel, and thus block rotation of the overhead shaft, in the event of a failure of the counterbalancing system of the door. The brake device further includes a locking assembly configured to cooperate with the ratchet wheel so as to securely mount the same onto the overhead shaft and thus prevent the ratchet wheel from being displaced along a longitudinal axis of the overhead shaft.

### FIELD OF THE INVENTION

The present invention relates to a brake device for garage doors and the like, also commonly known in the industry and referred to herein as a “spring break device” (“SBD”) or a “drop-catch mechanism”. The present invention also relates to a kit for assembling the brake device, and to a door assembly provided with the same.

### BACKGROUND OF THE INVENTION

Garage doors and the like are well known in the art. Indeed, it is well known in the art that garage doors usually require to be connected to a counterbalancing system for counterbalancing the weight of the door in order to decrease the force required to open the door and also facilitate its closing from a raised to a lowered position. Counterbalancing systems can be found in many other types of cable-operated doors, such as slidable truck doors for example.

It is also known in the art that a widely used type of counterbalancing system generally comprises a pair of spaced apart cable drums connected to corresponding cables, each cable being in turn connected to a lower opposite side edge of the garage door. The cable drums are usually mounted on an overhead shaft which is supported above the door opening and is connected to one or more torsion springs which are each fixed to the shaft at one end, and operatively secured to a fixed structure such as the wall, or a wall bracket for example, at the other end, so that the cable drums are biased to rotate in a direction which winds the cables onto the drums and counteracts the weight of the door connected to the cables. The torsion springs are adjusted to properly balance the weight of the door so that minimal opening and closing efforts are required, either manually or when motor controlled.

It is also known in the art that conventional, low cost adjustment devices used for the above-mentioned type of counterbalancing system, and widely utilized in the garage door industry, are generally cylindrical “collars” commonly referred to also as “plugs” (or “cones”) which are connected to the ends of the torsion springs and are thus mounted on the aforementioned shaft for adjusting the deflection of the springs to preset the torsional (or counterbalancing) force of the spring.

In operation, torque is transferred between the torsion spring, overhead shaft, and plugs which operatively connect the shaft to the spring, in order to counterbalance the weight of the garage door. Usually, each torsion spring is fixed to the overhead shaft at one end, by means of a plug known as a “winding plug”, and operatively secured to the wall via a bracket at the other end, by means of another plug known as a “stationary plug”.

Known in the art are many brake devices used with garage doors and the like.

U.S. Pat. No. 6,862,845 granted to SCHIKS on Mar. 8, 2005, describes a drop-catch mechanism. The drop-catch mechanism is used for preventing a door leaf of an overhead door from falling down upon breakage of a balancing spring thereof. The mechanism comprises an input member for coupling with a balancing spring of the overhead door. The mechanism also comprises a ratchet wheel for coupling with a winding axle carrying the door leaf of the overhead door. The mechanism also comprises a pawl and means for moving the pawl from a free position that allows rotation of the ratchet wheel to a catching position that blocks rotation of the ratchet wheel. The means for moving the pawl are configured such that, in use, breakage of a balancing spring coupled to the input member causes the pawl to move from the free position to the catching position. The mechanism is characterized in that the means for moving the pawl from the free position into the catching position comprise a positive mechanical drive extending from the input member to the pawl.

A drawback associated with the device described in the above-mentioned patent is that it is not teach to have a flange on its ratchet wheel, which in turn allows an axial movement of its ratchet wheel, which could be disadvantageous, for different reasons, as is well known in the art.

Also known to the Applicant are the following US patents and patent application which describe various devices for use with door assemblies: U.S. Pat. Nos. 229,983; 603,237; 636,645; 826,284; 1,196,714; 1,863,961; 2,463,344; 2,546,081; 2,555,560; 2,878,865; 3,236,348; 3,842,892; 3,895,539; 4,116,314; 4,125,142; 5,257,685; 5,494,093; 5,706,552; 5,971,055; 6,070,641; 6,079,524; 6,102,480; 6,401,792; 6,431,619; and 2002/0170688 A1.

Also known to the Applicant are the following foreign patents and/or patent applications which also describe various devices for use with door assemblies: DE 93 10 792 U (HÖRMANN KG) made public on Jun. 30, 1994; DE 44 12 421 A (SCHIEL, HANS-JOSEF) made public on Nov. 2, 1995; DE 201 12 521 U (NOVOFERM GMBH) made public on Nov. 29, 2001; and EP 1,213,428 A (FLEXI FORCE BV) made public on Jun. 12, 2002.

Also known in the art is U.S. Pat. No. 6,986,378 B2 granted on Jan. 17, 2006, to BEAUDOIN et al., and belonging to the same Assignee of the present application, which describes a braking device for garage doors and the like. A braking device configured for use with the counterbalancing system of a garage door. The braking device includes a support bracket, a ratchet wheel, a pawl arm, and a biasing spring. The support bracket is rigidly connected to a fixed structure and has a guiding slot. The ratchet wheel is securely mounted about the overhead shaft of the counterbalancing system and has at least one notch. The pawl arm has first and second ends, the first end of the pawl arm being pivotally connected to the support bracket and the second end of the pawl arm cooperating with the guiding slot and being movable with respect to the support bracket along said guiding slot. The first and second ends of the pawl arm are further connected to flanges of a plug on either side of the overhead shaft. The biasing spring is operatively connected between the support bracket and the pawl arm so as to exert a biasing force for biasing the pawl arm towards the ratchet wheel. The pawl arm is devised so that, an element thereof is adjacent to the ratchet wheel, said element being shaped and sized to be removably insertable into at least one notch of the ratchet wheel so as to block rotation of the ratchet wheel, and thus block rotation of the overhead shaft, in the event of a failure of the counterbalancing system of the door.

Also known in the art is International patent application No. PCT/CA2005/001257 made public on Feb. 23, 2006, under WO 2006/017931 A1, to BEAUDOIN et al., and belonging to the same Assignee of the present application, which describes a brake device for garage doors and the like, and door assembly including the same.

It is also known in the art that tubular round shafts are generally used for residential door assemblies. Some of these tubular shafts are formed with a keyway, which allows the use of a key to transmit torque through the device, but mostly, round-shaped shafts are typically used. This round shape typically prevents the use of conventional locking means, such as a key. It is also known in the art however that setscrews are widely used as a locking means for these types of round shafts. However, these types of fasteners generally do not offer a mechanical lock of a corresponding ratchet wheel on the overhead shaft, because very often, these conventional ratchet wheels will rely on friction essentially, as a driving and/or locking means. Therefore, it would be very useful to provide a non-friction mechanical locking means to be used on a ratchet wheel of known braking devices when said ratchet wheel is used on a round tubular shaft (generally, an overhead shaft of a door assembly) or when the use of a shaft key is not possible.

Also known in the art is a product commercialized by Flexiforce, where a component is added to a conventional spring break device. This product is commercialized as such, and a potential rubbing or friction problem may occur as a result namely of the fact that the ratchet wheel may disalign itself.

Also known in the art is another conventional spring break device, commercialized by an European company, where it is obvious also that there may be a rubbing or friction problem between the ratchet wheel and the lock, as a result of a non-optimal design.

Hence, in light of the aforementioned, there is a need for an improved device, which by virtue of its design and components, would be able to overcome some of the above-discussed prior art problems.

### SUMMARY OF THE INVENTION

The object of the present invention is to provide a brake device (or “ratchet wheel assembly”) which, by virtue of its design and components, satisfies some of the above-mentioned needs and is thus an improvement over other related brake devices known in the prior art.

The present invention is particularly advantageous in that it is intended for immobilizing a cable-operated door, such as garage doors and the like, in the event of a failure in the counterbalancing system. The present invention is also particularly advantageous in that its design is also intended to be used for improving the performance and/or reliability of a conventional brake device when it is used with a round tubular overhead shaft of a garage door assembly, and the like.

In accordance with the present invention, the above object is achieved, as will be easily understood, with a brake device such as the one briefly described herein and such as the one exemplified in the accompanying drawings.

More particularly, and according to the present invention, there is provided a brake device configured for cooperating with a counterbalancing system of a door, said counterbalancing system including a rotatable overhead shaft operatively connectable to the door for operating the same, a plug mountable about the overhead shaft and being rotatable thereabout, and a torsional spring for operatively connecting the plug to the overhead shaft and capable of being loaded thereinbetween so as to exert a torsional force for counterbalancing the weight of the door, said torsional force being transmittable between the overhead shaft and the plug via the torsional spring, the brake device being devised for blocking rotation of the overhead shaft in the event of a failure of the counterbalancing system of the door, the brake device comprising:

a support bracket rigidly connectable to a fixed structure, said support bracket having a guiding arrangement;

a ratchet wheel having an outer surface and an inner bore securely mountable about the overhead shaft of the counterbalancing system, the outer surface of the ratchet wheel having at least one notch;

a pawl arm having first and second ends, the first end of the pawl arm being pivotably connectable to the support bracket and the second end of the pawl arm cooperating with the guiding arrangement and being movable with respect to the support bracket along a given path defined by the guiding arrangement, the first and seconds ends of the pawl arm being further connectable to flanges of the plug on either side of the overhead shaft, the pawl arm further having an element adjacent to the ratchet wheel, said element being shaped and sized to be removably insertable into said at least one notch of the ratchet wheel so as to block rotation of the ratchet wheel; and

biasing means operatively connected between the support bracket and the pawl arm so as to exert a biasing force for biasing the pawl arm and its element towards the ratchet wheel;

wherein the pawl arm is operable between a first configuration, corresponding to a normal operation of the counterbalancing system, where the torsional force of the torsional spring transmitted to the plug is greater than the biasing force of the biasing means acting on the pawl arm, thereby urging the pawl arm and its element away from the ratchet wheel, thus allowing the overhead shaft to rotate, and a second configuration, corresponding to a failure of the counterbalancing system, where the biasing force of the biasing means acting on the pawl arm is greater than the torsional force of the torsional spring transmitted to the plug, thereby urging the element of the pawl arm into said at least one notch of the ratchet wheel so as to block rotation of the pawl arm and thus block rotation of the overhead shaft;

the improvement wherein the brake device further comprises a locking assembly configured to cooperate with the ratchet wheel so as to securely mount the same onto the overhead shaft and thus prevent the ratchet wheel from being displaced along a longitudinal axis of said overhead shaft.

Preferably, the locking assembly comprises at least one hole provided on the ratchet wheel, said at least one hole extending from the outer surface of the ratchet wheel to the inner bore thereof, the locking assembly further comprising at least one fastener shaped and sized for inserting into said at least one hole and for penetrating the overhead shaft, for positively locking the ratchet wheel with respect to the overhead shaft, and thus preventing the ratchet wheel from being displaced along the longitudinal axis of said overhead shaft.

Preferably also, the at least one fastener comprises a screw having a head and a shaft portion, the shaft portion of the screw comprising a first portion deprived of threading, a second portion provided with threading components, and a third portion provided with self-drilling components, and the head of the screw being countersunk and provided with a socket.

Preferably also, the locking assembly comprises at least one other hole provided on the ratchet wheel, said at least one other hole extending from the outer surface of the ratchet wheel to the inner bore thereof, and the locking assembly further comprising at least one other fastener shaped and sized for inserting into said at least one other hole and securing against the overhead shaft for securing the ratchet wheel against the overhead shaft.

Preferably also, said at one other fastener comprises at least one setscrew.

Preferably also, the ratchet wheel comprises a plurality of notches, the element of the pawl arm being removably insertable into one of said notches when the pawl arm is triggered into the second configuration, said at least one other fastener comprising a pair of setscrews, and each hole being positioned about corresponding notches on the outer surface of the ratchet wheel.

Preferably also, each hole is threaded for receiving a complementary threading of a corresponding fastener.

Preferably also, the brake device further comprises a bearing assembly configured to cooperate between the ratchet wheel and the support bracket so as to reduce possible friction thereinbetween.

Preferably also, the bearing assembly comprises a flange provided on a side of the ratchet wheel positionable adjacent to the support plate, and a ring made of a substantially resilient material mountable about said flange so as to act as a friction barrier between the support plate and the ratchet wheel.

Preferably also, the ring comprises a chamfered clip shaped and sized to be mounted about a rim of the flange of the ratchet wheel, and the ring further comprises at a least one bearing surface extending substantially parallel to the flange of the ratchet wheel so as to act as a friction barrier between the support plate and said ratchet wheel.

According to yet another aspect of the present invention, there is also provided a substantially resilient plastic clip such as the one briefly described herein and such as the one exemplified in the accompanying drawings, to be used with the above-mentioned brake device.

According to yet another aspect of the present invention, there is also provided a door assembly (e.g. a garage door) provided with the above-mentioned brake device and/or clip.

According to yet another aspect of the present invention, there is also provided a method for installing and/or operating the above-mentioned brake device and/or clip.

According to yet another aspect of the present invention, there is also provided a kit for assembling the above-mentioned brake device, clip and/or door assembly.

According to yet another aspect of the present invention, there is also provided a method for assembling components of the above-mentioned kit.

The objects, advantages and other features of the present invention will become more apparent upon reading of the following non-restrictive description of preferred embodiments thereof, given for the purpose of exemplification only with reference to the accompanying drawings.

### BRIEF DESCRIPTION OF THE DRAWINGS

FIG. 1 is a fragmentary exploded view of a counterbalancing system of a door assembly provided with a brake device according to a preferred embodiment of the present invention, the brake device being shown in a first operating configuration.

FIG. 2 is a plan view of a ratchet wheel shown in an exploded relationship with fasteners to be used therewith according to a preferred embodiment of the present invention.

FIG. 3 is a side view of one of the fasteners shown in FIG. 2.

FIG. 4 is a top view of the fastener shown in FIG. 3.

FIG. 5 is a fragmentary exploded view of a counterbalancing system of a door assembly provided with a brake device according to yet another preferred embodiment of the present invention, the brake device being shown in a first operating configuration.

FIG. 6 is a cross-sectional view of a portion of a brake device provided with a clip according to a preferred embodiment of the present invention.

FIG. 7 is an exploded view of what is shown in FIG. 6.

FIG. 8 is a perspective view of what is shown in FIG. 7, better illustrating the fasteners to be used with the ratchet wheel according to a preferred embodiment of the present invention.

FIG. 9 is a side elevational view of the clip shown in FIG. 8.

FIG. 10 is a front plan view of what is shown in FIG. 9.

FIG. 11 is a rear plan view of what is shown in FIG. 9.

FIG. 12 is an enlarged view of a portion (XII-XII) of what is shown in FIG. 9.

FIG. 13 is a side view of a fastener to be used with a brake device according to a preferred embodiment of the present invention.

FIG. 14 is a top view of what is shown in FIG. 13.

FIG. 15 is a front view of a mounting bracket provided with a brake device according to a preferred embodiment of the present invention, the brake device being shown in another operating configuration.

### DETAILED DESCRIPTION OF PREFERRED EMBODIMENTS OF THE INVENTION

In the following description, the same numerical references refer to similar elements. The embodiments shown in the figures are preferred, for exemplification purposes only.

In the context of the present description, the expression “garage door” includes all types of cable-operated doors and the like, including access openings, using one or more torsion springs for the counterbalancing the weight of the given door. Although the present invention was primarily designed for a garage door, it may be used with other kinds of doors, such as slidable truck doors, or with any other items using a counterbalancing system, as apparent to a person skilled in the art. For this reason, the expression “garage door” should not be taken as to limit the scope of the present invention and includes all other kinds of doors or items with which the present invention may be used and could be useful.

Moreover, in the context of the present description, the expressions “garage”, “door” and “door assembly”, “torsion spring” and “torsional spring”, “counterbalancing shaft” and “overhead shaft”, “counterbalancing mechanism” and “counterbalancing system”, “device”, “assembly” and “ratchet wheel”, “tube” and “shaft”, as well as any other equivalent expressions and/or compound words thereof, such as “fastener”, “screw” and “setscrew”, may be used interchangeably. The same applies for any other mutually equivalent expressions, such as “plate” and “bracket” for example, as apparent to a person skilled in the art.

In addition, although the preferred embodiment of the present invention as illustrated in the accompanying drawings comprises various components such as fastener(s) 51, a ratchet wheel 13, a bracket 11, a guiding slot 45, a plurality of pivots, etc., and although the preferred embodiment of the brake device 1 and corresponding parts of the present invention as shown consists of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for the brake device 1 according to the present invention, as will be briefly explained herein and as can be easily inferred herefrom, without departing from the scope of the invention.

Broadly described, the brake device 1 according to the present invention, as exemplified in the accompanying drawings, is a brake device 1 for use with a counterbalancing system 3 (partially shown) of a door, such as a garage door, for immobilizing the door in the event of a failure in the counterbalancing system 3, in a manner similar to that of a “spring break device” or a “drop-catch mechanism”, for blocking the rotation of the shaft 5 of the counterbalancing mechanism 3.

More particularly, and according to a preferred application, the present invention relates to a ratchet wheel assembly for use with tubular shafts and the like, typically counterbalancing shafts 5 of garage doors and the like, to be used in conjunction with what is described in U.S. Pat. No. 6,986,378 or International patent application No. PCT/CA2005/001257 (made public Feb. 23, 2006 under WO 2006/017931 A1) belonging to the Assignee of the present application, the contents of which are both incorporated herein by reference. More specifically, the present invention also relates to a manner of assembling a specific component (e.g. ratchet wheel 13 and corresponding resilient antirub clip 63) of the assembly to the garage door shaft 5, and to prevent or at the very least minimize inconveniences due to a misinstallation of the assembly.

As can be easily understood by a person skilled in the art when referring to the accompanying drawings, the brake device 1 is configured for use with the counterbalancing system 3 of the door which, among other components, typically includes a rotatable overhead shaft 5 operatively connected to the door for operating the same, a plug 7 mounted about the overhead shaft 5 and being rotatable thereabout, and a torsional spring 9 operatively connecting the plug 7 to the overhead shaft 5 and being loaded thereinbetween so as to exert a torsional force capable of counterbalancing the weight of the door, the torsional force being transmittable between the overhead shaft 5 and the plug 7 via the torsional spring 9. Counterbalancing systems 3 of garage doors are very well known in the art and thus, in the context of the present description, there is no need to further explain the working principle thereof, as apparent to a person skilled in the art.

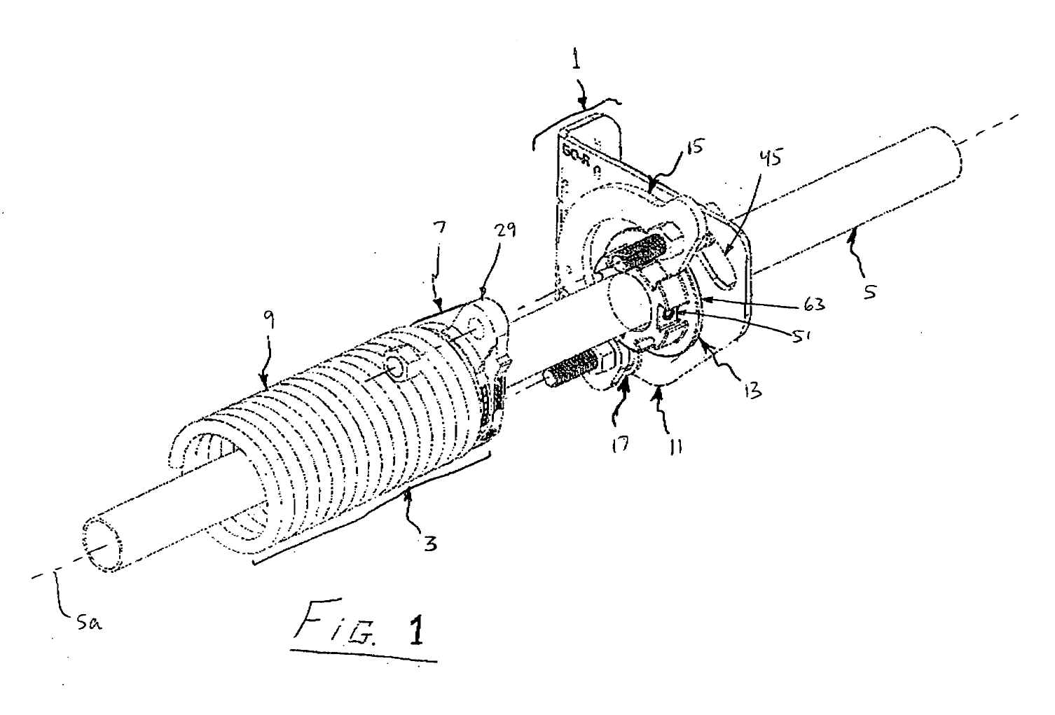

According to the present invention, the brake device 1 is used for blocking rotation of the overhead shaft 5 in the event of a failure of the counterbalancing system 3 of the door. The brake device 1 comprises a support bracket 11, a ratchet wheel 13, a pawl arm 15, biasing means 17 (e.g. a spring 17 or any other suitable way providing of a biasing force, as apparent to a person skilled in the art), and at least one pivot, as better shown in FIG. 1.

As can be easily understood by a person skilled in the art in reference to the accompanying drawings, the support bracket 11 is rigidly connected to a fixed structure, such as a wall for example, or any other suitable structure. The brake device 1 also has a guiding arrangement, which preferably includes a guiding slot 45 provided on the support bracket 11. It is worth mentioning though that, according to the present invention, the guiding arrangement may be disposed otherwise on the brake device 1 and/or on other parts of the counterbalancing system 3 with which it cooperates, as briefly described hereinbelow and as apparent to a person skilled in the art.

Preferably also, the ratchet wheel 13 is securely mounted about the overhead shaft 5 of the counterbalancing system 3 and has at least one notch 23. Preferably, the ratchet wheel 13 is securely mounted about the overhead shaft 5 by means of suitable fasteners 51, such as setscrews 37 or a transversal pin for example. Preferably also, the ratchet wheel 13 may further comprise an outer surface 13a and an inner bore 13b.

An important aspect of the present invention resides in the fact that the brake device 1 preferably comprises securement and/or anti-friction components. Indeed, the brake device 1 according to a preferred embodiment of the present invention preferably comprises the above-mentioned ratchet wheel 13, which is preferably provided with a round inner bore 13b and at least one hole 13c, preferably three (3), as better exemplified in FIG. 2, to receive corresponding fasteners 51. Preferably also, two of these holes 13c are threaded so as to receive corresponding setscrews 37. Preferably also, the ratchet wheel 13 is also devised so as to have a flange 13d for a self aligning feature with respect to the rest of the components of the brake device 1 and/or door assembly.

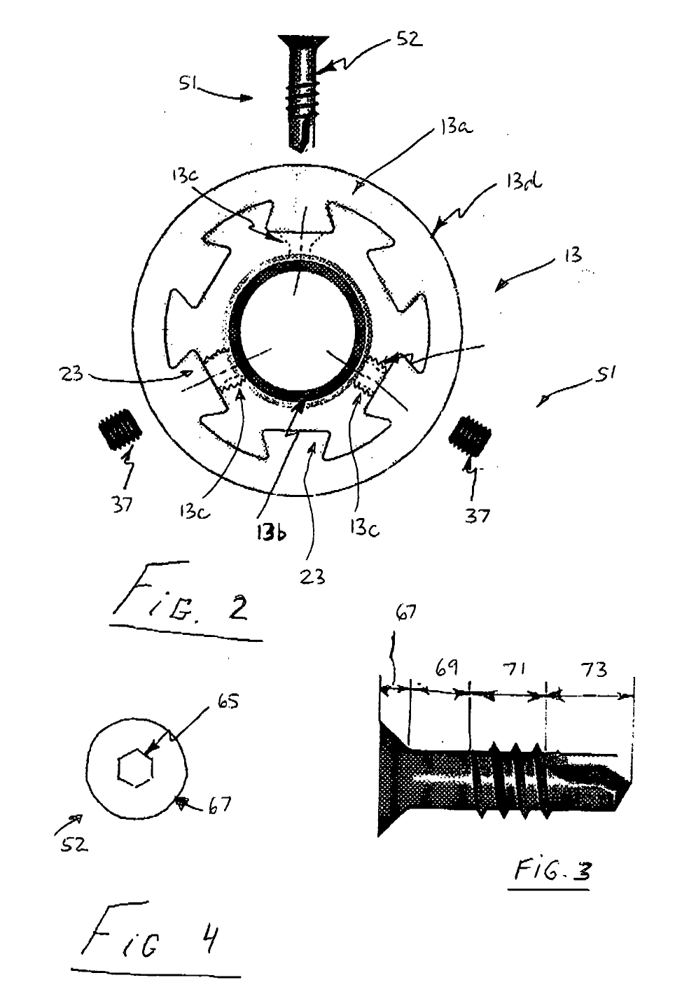

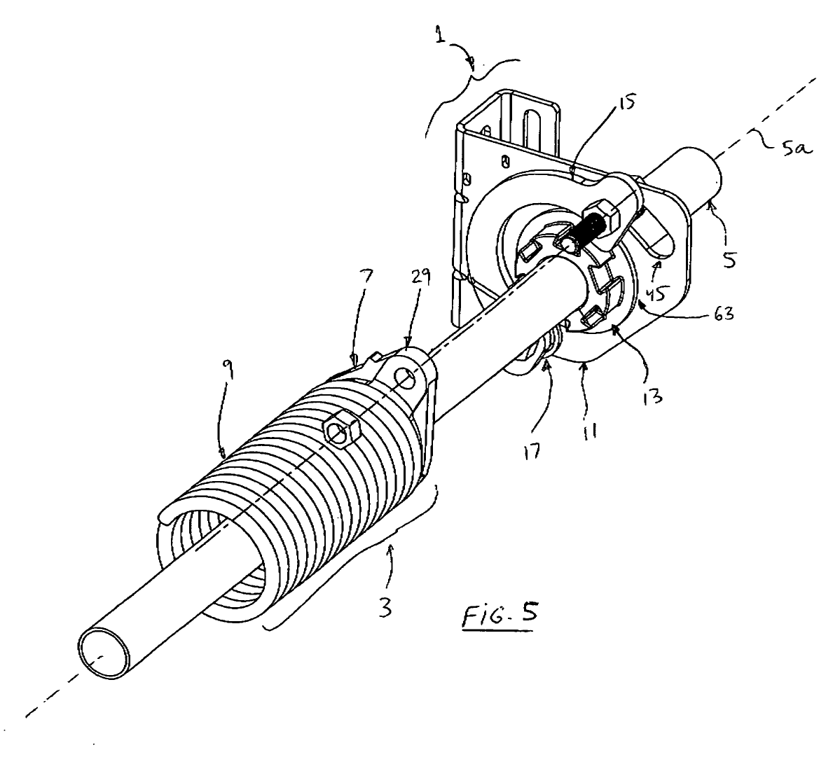

Preferably also, the above-mentioned two (2) setscrews 37 are used for operatively locking the ratchet wheel 13 to the shaft 5, preferably by friction, as can be easily understood by a person skilled in the art when referring to FIG. 2. Furthermore, the third fastener 51 (i.e. screw 52) illustrated therein, and better shown in FIGS. 3 and 4, which is preferably a mechanical lock fastener, allows the ratchet wheel 13 to transmit torque to the braking device, as can be easily understood by a person skilled in the art. This particular fastener 51 (i.e. screw 52) has a preferred six (6) distinct features which are briefly explained hereinbelow, in reference to the accompanying drawings.

It is worth mentioning that, according to the present invention, other suitable means different from the above-discussed may be used for securely mounting the ratchet wheel 13 about the overhead shaft 5, at a suitable location therealong, as apparent to a person skilled in the art.

Indeed, the use of a half dog setscrew 37, with a drilled hole in the shaft 5, also allows for a mechanical and positive lock of the ratchet wheel 13 with respect to the overhead shaft 5. This requires an additional installation step, because an installer typically needs to drill a hole in the overhead shaft 5. Also, conventional setscrews 37 do not necessarily allow the installer to visually make sure the setscrews 37 are tightened on the shaft 5 and correctly installed. Thus, with the ratchet wheel 13 and corresponding fasteners 51 according to the present invention, if these fasteners 51 (and more particularly, screw 52) are installed flush to the ratchet wheel surface, one is ensured, by virtue of the design of the ratchet wheel 13 as exemplified in the accompanying drawings, that the ratchet wheel 13 is mechanically and positively locked to the overhead shaft 5. Preferably, the above-described mechanical lock fasteners 51 are designed (dimension, configured, made of a suitable material, etc.) so as to sustain a possible impact load in the event of a failure of the counterbalancing system 3. Indeed, it is known in the art that, for a same diameter, a threaded fastener 51 may not sustain an impact load as high as the proposed solution of the present invention, namely and preferably, a round circular section without a stress concentrating geometry. Indeed, this geometry and solution, as better exemplified in FIG. 3, can allow a higher rating of the braking device 1.

Moreover, the use of a spring pin can also mechanically lock the ratchet wheel 13 to the shaft 5, but this means that an installer needs to drill two aligned holes in a shaft 5, which represents an additional installation step. Another solution would be to have the ratchet wheel 13 welded to the shaft 5, but this is a big compromise for disassembly or replacement of parts related to the counterbalancing system 3. The use of mechanical locking shapes on the overhead shaft (keyways, hexagonal shafts, spline, etc.) could also solve these different assembling concerns, but would also increase the cost of the garage door assembly and complexity of manufacturing such tubular shafts 5.

Thus, as may now be better appreciated, the brake device 1, corresponding ratchet wheel 13 and components according to the present invention, as exemplified in FIGS. 2-4, is particularly advantageous in that it enables to improve the performance and the reliability of the brake device 1 when used on a round tubular overhead shaft 5 of a garage door assembly and the like.

Indeed, as can now be better understood when referring to FIG. 2 of the present application, the ratchet wheel 13 according to the present invention is preferably provided with at least one fastener 51, but preferably three (3) fasteners 51, which are preferably used to secure it onto the overhead shaft 5. Preferably, the ratchet wheel 13 comprises at least one threaded hole 13c, but preferably a pair of such threaded holes 13c, for receiving the corresponding two (2) setscrews 37 to be fastened therein and onto the overhead shaft 5. Preferably also, as also illustrated in FIG. 2, the ratchet wheel 13 also comprises at least one countersunk hole 13c for receiving and fastening therein, into the corresponding overhead shaft 5, the corresponding lock screw 52. According to a preferred embodiment of the present invention, the two (2) setscrews 37 are preferably first used to lock by friction the ratchet wheel 13 onto the overhead shaft 5. Then, an installer can add the mechanical lock screw 52 which is also self-drilling, preferably. As can be easily understood by a person skilled in the art when referring to FIGS. 2-4, the two (2) setscrews 37 ease the installation of the device 1 by preventing the ratchet wheel 13 from moving while assembling subsequently the corresponding lock screw 52. All of these three (3) preferred fasteners 51 are preferably chosen so that once installed, they do not protrude from the ratchet wheel 13, this enabling also to advantageously insure a proper operation and functioning of the brake device 1, and of its pawl arm 15.

Referring now to FIGS. 3 and 4, there is shown preferred particular details of the locking fastener 51 according to the present invention. Indeed, as previously explained, six (6) preferred main features characterize this mechanical lock screw 52. Firstly, it preferably comprises an hexagonal socket 65, similar to the ones used on conventional setscrews 37, thus allowing an installer to use only one tool for the installation of the ratchet wheel system. Preferably also, it has a countersunk head 67 so that once assembled, in the ratchet wheel hole, it does not protrude therefrom. Preferably also, it has a round section 69 (i.e. a “first section” 69) without any threads, which preferably acts as a shear section in case of impact on the ratchet wheel 13. By being preferably round, this avoids stress concentration factors due to the shape of the threads. Furthermore, the length of this non-threaded portion 69, is also advantageous because it preferably prevents the fastener 51 from being removed once it has been assembled into the overhead shaft 5. By having no threads on this particular portion of the lock screw 52, the lock screw 52 preferably strips itself once it has been installed.

Preferably also, it has a threaded portion 71 (i.e. a “second section” 71) that is self-threading and allows it to be screwed through the ratchet wheel hole and corresponding tubular shaft 5, as can be easily understood by a person skilled in the art. Preferably also, the above-mentioned screw 52 also comprises a self-drilling portion 73 (i.e. a “third section” 73) which allows the installer to use it without drilling any holes in the overhead shaft 5, and that makes it also easier to install than other available solutions. Preferably also, the above-mentioned locking fastener 51 (i.e. screw 52) is made in stainless steel to give it sufficient mechanical properties in the unlikely event of a failure of the counterbalancing system 3 and also to prevent premature corrosion.

Furthermore, as aforementioned, the guiding arrangement of the support bracket 11 preferably comprises a guiding slot 45, preferably provided on the support bracket 11, which preferably acts as the given path along which the second end of the pawl arm 15 may travel. Preferably also, the brake device comprises suitable fasteners for connecting the first and second ends of the pawl arm 15 to the flanges 29 of the plug, one of the fasteners being preferably mounted onto the second end of the pawl arm 15 and cooperating with the guiding slot 45 of the support bracket 11 for allowing the second end of the pawl arm 15 to move along the guiding slot 45 of the support bracket, as can be easily understood when referring to FIG. 1. The fasteners may simply consist of a member having a first end securely connected to the second end of the pawl arm 15 and a second end cooperating with the guiding arrangement (e.g. slot 45) of the support bracket 11. Alternatively, the fasteners may consist of a bolt combined with other suitable complementary pieces, such as a nut, a washer, a spacer, a bearing, and/or the like, as apparent to a person skilled in the art.

As can be easily understood from FIG. 1, the pawl arm 15 further has an element 31 adjacent to the ratchet wheel 15, said element being shaped and sized to be removably insertable into at least one notch 23 of the ratchet wheel 13 so as to block rotation of the ratchet wheel 13 when there is a failure of the counterbalancing system 3.

In use, the pawl arm 15 is operable between a first configuration, also known as “unlocked configuration” or “rest configuration”, corresponding to a normal operation of the counterbalancing system 3, where the torsional force of the torsional spring 9 transmitted to the plug 7 is greater than the retaining force and/or disposition of the pivot(s) acting on the pawl arm 15, thereby urging the pawl arm 15 and its element 31 away from the ratchet wheel 15, thus allowing the overhead shaft 5 to rotate and operate normally, as apparent to a person skilled in the art.

The pawl arm 15 is also operable and may be triggered into a second configuration, also known as the “locked configuration” or “brake configuration”, corresponding to a failure of the counterbalancing system 3, where the retaining force and/or disposition of the pivot(s) acting on the pawl arm 15 is greater than the torsional force of the torsional spring 9 transmitted to the plug 7, thereby urging the element 31 of the pawl arm 15 into at least one notch 23 of the ratchet wheel 13 so as to block rotation of the pawl arm 15 and thus block rotation of the overhead shaft 5, as can also be easily understood by a person skilled in the art when referring to FIG. 1.

It is worth mentioning that although the preferred embodiment of the guiding arrangement includes a guiding slot 45 provided on the support bracket 11, other suitable guiding arrangements different from the above-discussed may be used for the brake device 1 according to the present invention, without departing from the scope of the present invention. For example, the support bracket 11 may not even need to be provided with a guiding slot 45. Indeed, the support bracket 11 could be provided with an appropriate projecting member instead, such as a pin, which would be shaped and sized to cooperate with a corresponding guiding slot provided on the second end of the pawl arm 15 so as to ensure a proper cooperation thereinbetween and ensure that the second end of the pawl arm 15 may be displaced from one end to another along the predetermined given path so that the pawl arm 15 may be properly triggered from the first configuration into the second configuration so as to ensure that its element 31 is securely insertable into one of the notches 23 of the ratchet wheel 15, so as to block rotation of the overhead shaft 5, in the event of a failure of the counterbalancing system 3. Moreover, it is worth mentioning that according to other variations of the present invention, the pawl arm 15 could be integrated into the plug 7 so that the latter two would consist of one single piece. Indeed, this modified plug 7 would thus have first and second ends, similarly to those described herein, and a corresponding element 31 being shaped and sized to be removably insertable into at least one notch 23 of the ratchet wheel 13 so as to block rotation of the ratchet wheel 13. Hence, as can be easily understood, other various types of guiding arrangements and substantial variations of the pawl arm 15 may be used according to the present invention so long as they ensure a proper displacement of the second end of the pawl arm 15 with respect to the support bracket 11 for ensuring blocking of the ratchet wheel 13 by means of element 31, and a corresponding cooperation and movement generated by the design/disposition of the pivot(s), thus insuring a desired movement of the plug 7 and a corresponding blocking of the overhead shaft 5, in the event of a failure of the counterbalancing mechanism 3.

Preferably also, the given path along which the second end of the pawl arm 15 may travel is preferably devised so that the displacement of the pawl arm 15 into the locked configuration forces the plug 9 of the counterbalancing mechanism 3 to be displaced eccentrically with respect to the longitudinal axis 5a of the overhead shaft 5 so as to facilitate the insertion of the element 31 of the pawl arm 15 into one of the plurality of notches 23 of the ratchet wheel 13, and thus adequately block rotation of the ratchet wheel 13, and thus of the overhead shaft 5, when there is a failure in the counterbalancing mechanism 3.

As better shown in FIG. 1, the ratchet wheel 13 preferably comprises a plurality of notches 23, and the element 31 of the pawl arm 15 is removably insertable into one of said notches 23 when the pawl arm 15 is triggered into the second configuration.

As also better shown in FIG. 1, the support bracket 11 preferably comprises an orifice through which the overhead shaft 5 extends. The orifice may preferably be provided with a bushing through which the overhead shaft 5 also extends, said bushing acting as a support for the overhead shaft 5 and also facilitating its rotation with respect to the support bracket 11, also known as a bearing plate.

Preferably also, the pawl arm 15 is arc-shaped, as also better shown in FIGS. 1, 5 and 15, and the first and second ends of the pawl arm 15 are preferably diametrically opposed to one another. It is worth mentioning though, as apparent to a person skilled in the art, that the first and second ends of the pawl arm 15 do not necessarily need to be diametrically opposite to one another, for proper operation of the brake device 1, that is, for a suitable blocking of the ratchet wheel 13 by the pawl arm 15 and its element 31. Indeed, the second end of the pawl arm 15 and corresponding guiding arrangement may be located at another suitable location on the support bracket 11 for providing a proper lever force so as to insert the element 31 of the pawl arm 15 securely into one of the notches 23 of the ratchet wheel 15 and adequately block rotation of the overhead shaft 5 when there is a failure in the counterbalancing mechanism 3.

As previously explained, during the normal operation of the door, the brake device 1 according to the present invention is in an unlocked configuration and acts as a wall bracket. In this mode, the counterbalancing shaft 5 is free to rotate either clockwise or counterclockwise so as to carry out its normal counterbalancing functions. This unlocked configuration is maintained because of the torsional force present in the torsional spring 9 which is stronger than the force exerted by the retaining force and/or disposition of the pivot(s). The torque caused by the torsional force present in the torsional spring member and the torque caused by a retaining force and/or triggering force due to disposition provided by the pivot(s) operatively connected between the plug 7 and the pawl arm 15 (and bearing plate). In the event of a failure in the counterbalancing mechanism 3 characterized by a substantial decrease in tension in the torsional spring 9, then the first torque becomes very small, therefore the combined effect of gravity on the door and the retaining force and/or triggering force due to disposition of the pivot(s) force the pawl arm 15 to engage with the ratchet wheel 13, as can be easily understood from FIGS. 1, 5 and 15, and thereby stop the door from falling. Indeed, when in the locked configuration, the counterbalancing shaft 5 is prevented from rotating because of the interlocking of the element 31 of the pawl arm 15 with a corresponding notch 23 of the ratchet wheel 15 mounted securely and coaxially about the counterbalancing shaft 5. Preferably and as apparent to a person skilled in the art, the shaft 5 may only be turned by raising the door or by appropriately disengaging the pawl arm 15 from the ratchet wheel 13. Hence, it can be easily understood that the brake device 1 according to the present invention acts similarly to a ratchet system which is triggered into action when there is a failure in the counterbalancing mechanism 3 of the door.

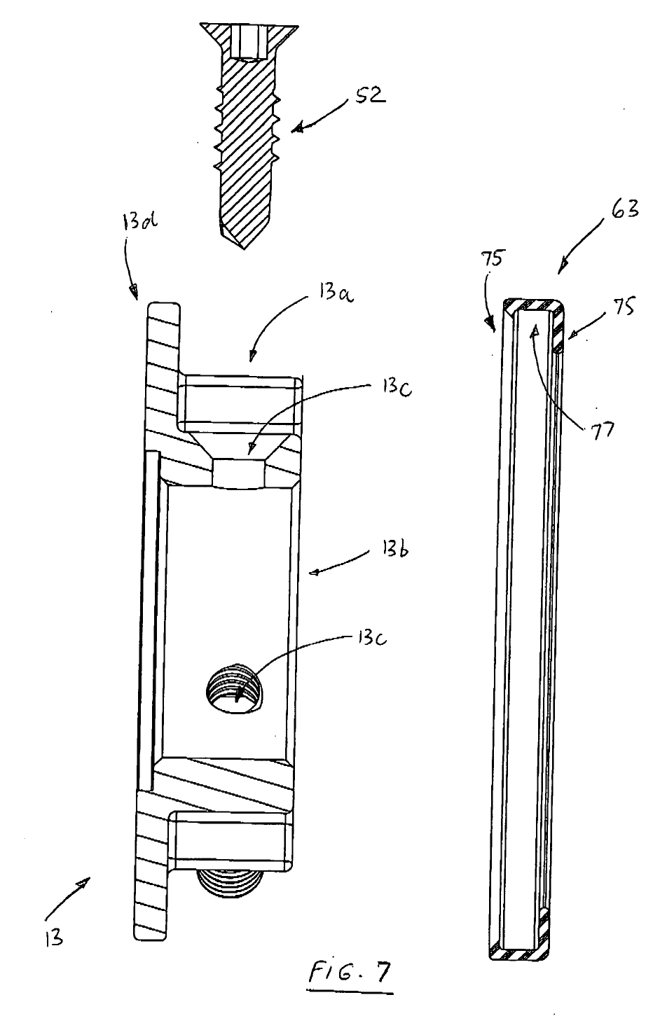

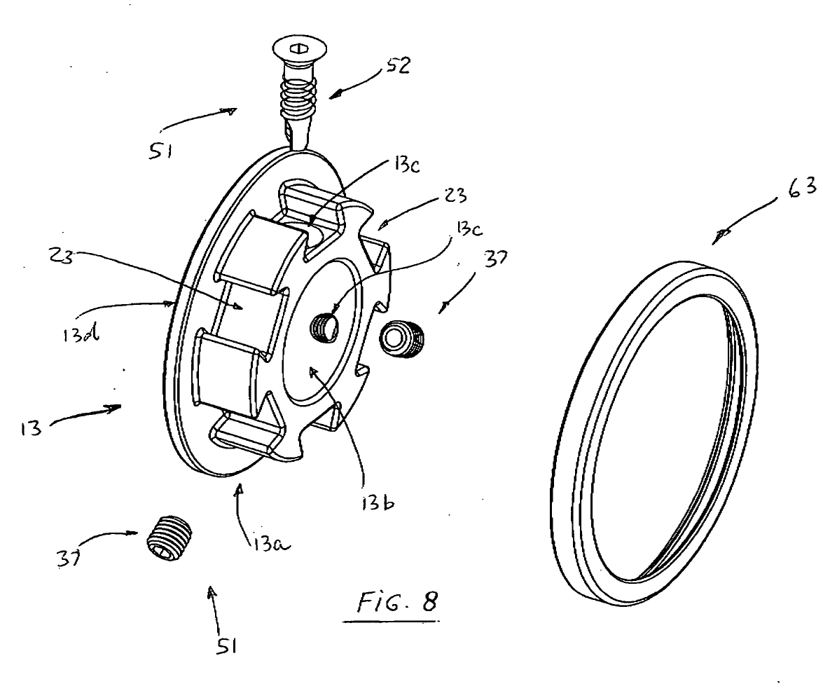

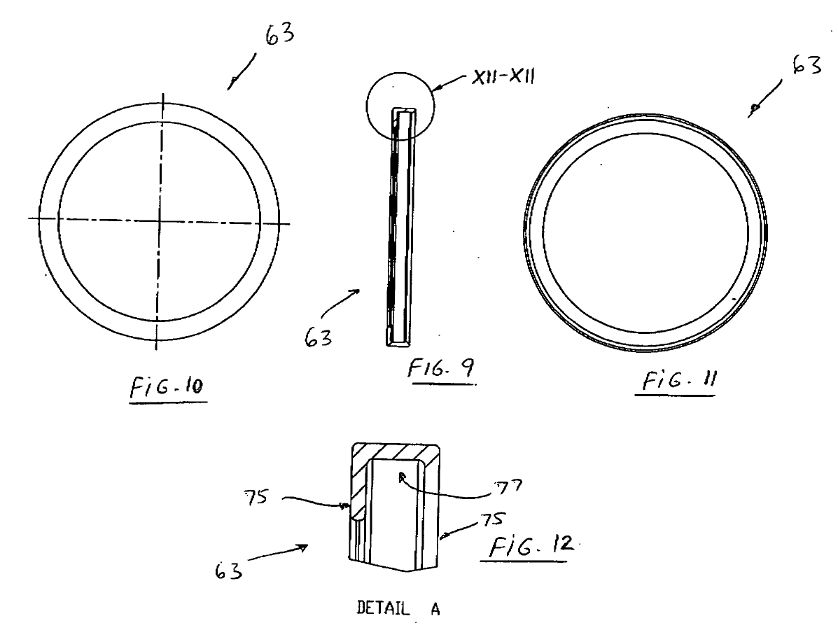

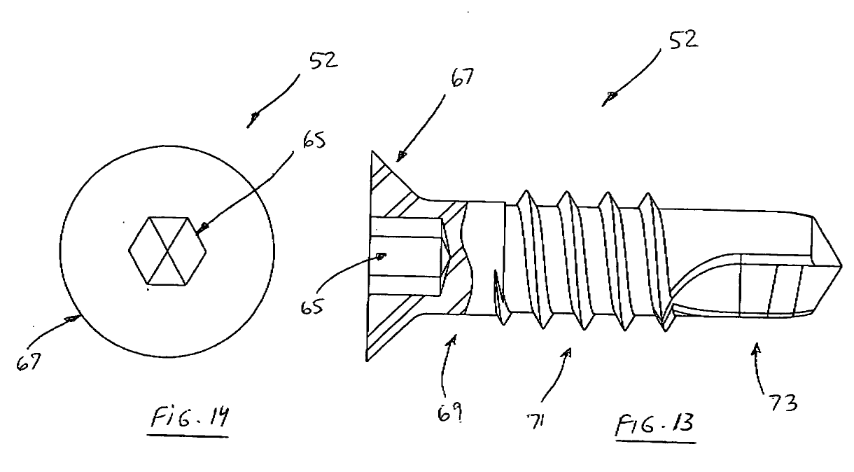

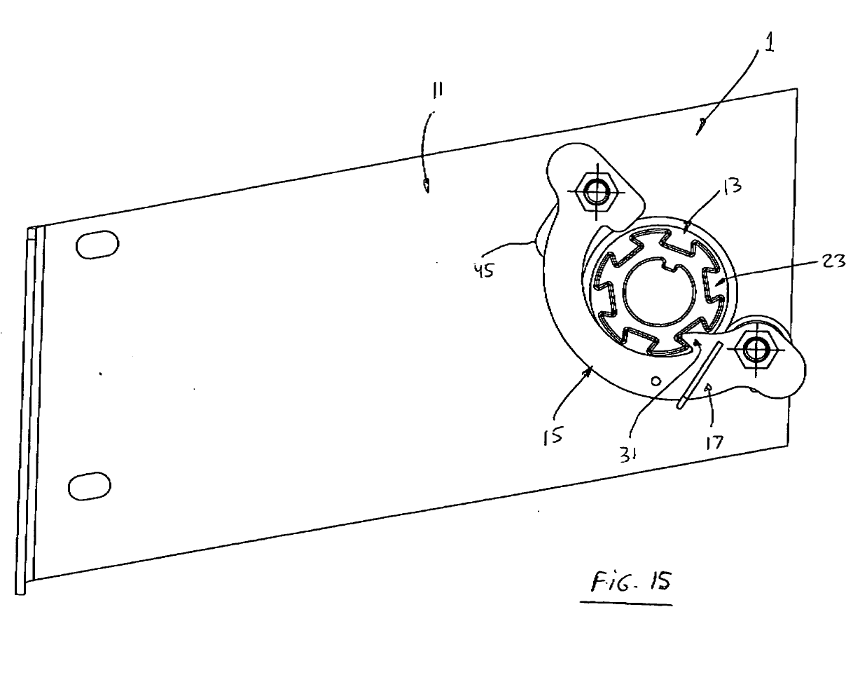

Several modifications could be made to the above-described brake device 1, without departing from the scope of the present invention, as can be easily understood by a person skilled in the art. Indeed, and for example, as better exemplified in FIGS. 5-15, a circular clip or ring 63 could also be added to prevent metal-to-metal contact between lock and ratchet wheel 13, and/or support plate 11. This clip or ring 63 is preferably made of a flexible or resilient plastic material to allow easy clipping, preferably manually, on the ratchet wheel 13. It is worth mentioning also that this plastic ring 63 could be made so that it can turn, or not, relatively to the ratchet wheel 13, after assembly, depending on the tolerances used and the end results desired, as can be easily understood by a person skilled in the art.

As better exemplified and illustrated in the accompanying drawings, the clip or ring 63 preferably comprises at least two (2) important features, namely: a) a vertical flange portion which acts as a bearing surface 75 against the lock; and b) a chamfered clip 77 to facilitate the installation on the ratchet wheel 13, but preferably also to prevent removal while the ratchet wheel 13 is submitted to an axial force.

The above-mentioned ring 63 is preferably configured and made so that once assembled onto the brake device 1, it protrudes from the ratchet wheel flange 13d, so as to prevent the ratchet wheel 13 from rubbing against the support plate 11, as can be easily understood when referring to FIGS. 5-12.

Preferably also, the width of the clip or ring 63 should be made so that, by design, there is still a gap between the ratchet wheel 13 assembled with ring 63 and the lock, to prevent the ring 63 from constant rubbing and still allow axial play, as can be also easily understood by a person skilled in the art.

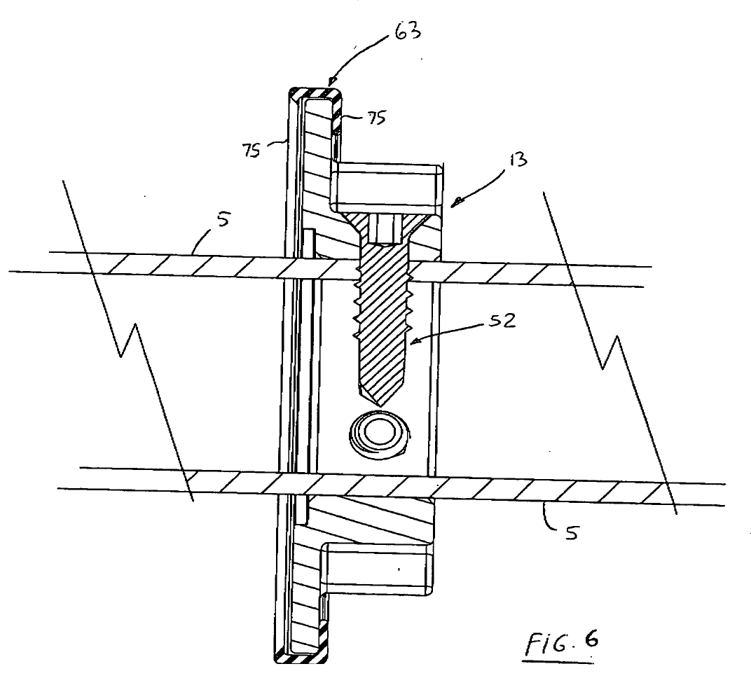

Preferably also, the flange portion of the ring 63 must not be too thick to allow the installer to screw the fasteners 51 used on the ratchet wheel 13, as can also be easily understood by a person skilled in the art when referring to FIGS. 6-14.

Several modifications could be made to the present clip or ring 63 without departing from the scope of the present invention in that, for example, different colors of plastic material could be used to differentiate the assembly side, namely right-hand side and left-hand side, as is well known in the art, a common example known in the garage door industry being that “black” is usually intended for left- hand side and “red” is usually intended for right-hand side.

Furthermore, the clip or ring 63 could also be used with other types of ratchet wheels 13 with a keyed bore model, for example. Thus, the color coding could be used again to differentiate the type of spring break device (SBD) for a keyed tubular shaft 5 or for a round tubular shaft 5, each type of SBD assembly having a defined color code, as is well known in the art.

Other suitable modifications could be made to the present clip or ring 63 without departing from the scope of the present invention, as also apparent to a person skilled in the art. Indeed, and for example, one could use a ratchet wheel 13 without a flange 13d and assemble it with a plastic part or a part in low friction alloy, like bronze, which would act as a flange 13d by means of the adhesive, rivets, fasteners, welding, and/or any other suitable means, as apparent to a person skilled in the art.

Furthermore, other embodiments that are contemplated with the present invention could reside in adding a low friction plastic on the lock and on the bearing plate, thus avoiding metal-to-metal contact between the ratchet wheel 13 and other parts, as can be easily understood by a person skilled in the art. Another suitable solution would reside in providing a ratchet wheel 13 made completely out of plastic, or any other suitable material.

Furthermore, the clip or ring 63 could also be used with other types of ratchet wheels 13 with a keyed bore model, for instance, as previously explained. Indeed, in such cases, the color coding could be used again to differentiate the type of SBD device for keyed tubular shafts 5 or for round tubular shafts 5, each type of SBD assembly having a defined color code.

It is worth mentioning also that the present clip or ring 63 could be used in a tensioning system such as the one exemplified in the accompanying FIG. 15.

Hence, it may be better appreciated in view of the above examples that the clip or ring 63 according to the present invention may take on various different embodiments, as apparent to a person skilled in the art.

The brake device 1 and corresponding parts (pawl arm 15, ratchet wheel 13, support bracket 11, pivot(s), fasteners 51, etc.) are preferably made of substantially rigid materials, such as metallic materials (stainless steel, etc.), hardened polymers, composite materials, polymeric materials, and/or the like, so as to ensure a proper operation thereof depending on the particular applications for which the brake device 1 is intended and the different parameters in cause (counterbalancing force in the spring, weight of the door, etc.), as apparent to a person skilled in the art.

Moreover, the brake device 1 shown in the accompanying figures is a “right” brake device 1 to be located at the top right portion of the garage door, more specifically at the right-hand side thereof when viewed from the inside of the garage. A “left” brake device 1, that is, a left-hand side version of the brake device 1 shown, would simply be a mirror image of what is in the accompanying figures.

The present invention is an improvement and presents several advantages over devices known in the prior art. Indeed, the present invention may be used in the garage door industry, with new garage doors or existing garage doors. In the case of a failure in the counterbalancing system 3, the present invention is devised to stop the fall of the garage door and maintain it immobilized where it is until the necessary inspections and repairs are made.

The present invention is a more compact, easier to use, easier to maintain, and more cost effective brake device 1 than those available in the prior art. Furthermore, the present invention may be used with other kinds of doors, such as slidable truck doors, or with any other items provided with counterbalancing mechanisms 3 such as the aforementioned, as apparent to a person skilled in the art. Moreover, the present invention is also particularly advantageous in that, as aforementioned, it enables the brake device 1 to be used with round tubular overheads shafts 5 of garage door assemblies and the like, especially when no positive locking means are present on the shaft 5. The present invention is also particularly advantageous in that the solution proposed of a plastic clip 63, configured and to be used with the ratchet wheel 13 in the manner described herein, is very inexpensive, easy to assemble without the use of fasteners or adhesive, and constitutes a single component being easily adaptable on a great variety of tolerances of ratchet wheels 13 which is usually molded.

Of course, numerous modifications could be made to the above-described embodiments without departing from the scope of the invention, as defined in the appended claims.

1. A brake device configured for cooperating with a counterbalancing system of a door, said counterbalancing system including a rotatable overhead shaft operatively connectable to the door for operating the same, a plug mountable about the overhead shaft and being rotatable thereabout, and a torsional spring for operatively connecting the plug to the overhead shaft and capable of being loaded thereinbetween so as to exert a torsional force for counterbalancing the weight of the door, said torsional force being transmittable between the overhead shaft and the plug via the torsional spring, the brake device being devised for blocking rotation of the overhead shaft in the event of a failure of the counterbalancing system of the door, the brake device comprising:
a support bracket rigidly connectable to a fixed structure, said support bracket having a guiding arrangement;
a ratchet wheel having an outer surface and an inner bore securely mountable about the overhead shaft of the counterbalancing system, the outer surface of the ratchet wheel having at least one notch;
a pawl arm having first and second ends, the first end of the pawl arm being pivotably connectable to the support bracket and the second end of the pawl arm cooperating with the guiding arrangement and being movable with respect to the support bracket along a given path defined by the guiding arrangement, the first and seconds ends of the pawl arm being further connectable to flanges of the plug on either side of the overhead shaft, the pawl arm further having an element adjacent to the ratchet wheel, said element being shaped and sized to be removably insertable into said at least one notch of the ratchet wheel so as to block rotation of the ratchet wheel; and
biasing means operatively connected between the support bracket and the pawl arm so as to exert a biasing force for biasing the pawl arm and its element towards the ratchet wheel;
wherein the pawl arm is operable between a first configuration, corresponding to a normal operation of the counterbalancing system, where the torsional force of the torsional spring transmitted to the plug is greater than the biasing force of the biasing means acting on the pawl arm, thereby urging the pawl arm and its element away from the ratchet wheel, thus allowing the overhead shaft to rotate, and a second configuration, corresponding to a failure of the counterbalancing system, where the biasing force of the biasing means acting on the pawl arm is greater than the torsional force of the torsional spring transmitted to the plug, thereby urging the element of the pawl arm into said at least one notch of the ratchet wheel so as to block rotation of the pawl arm and thus block rotation of the overhead shaft;
the improvement wherein the brake device further comprises a locking assembly configured to cooperate with the ratchet wheel so as to securely mount the same onto the overhead shaft and thus prevent the ratchet wheel from being displaced along a longitudinal axis of said overhead shaft.

2. A brake device according to claim 1, wherein the locking assembly comprises at least one hole provided on the ratchet wheel, said at least one hole extending from the outer surface of the ratchet wheel to the inner bore thereof, and wherein the locking assembly further comprises at least one fastener shaped and sized for inserting into said at least one hole and for penetrating the overhead shaft, for positively locking the ratchet wheel with respect to the overhead shaft, and thus preventing the ratchet wheel from being displaced along the longitudinal axis of said overhead shaft.

3. A brake device according to claim 2, wherein the at least one fastener comprises a screw having a head and a shaft portion, the shaft portion of the screw comprising a first portion deprived of threading, a second portion provided with threading components, and a third portion provided with self-drilling components, and the head of the screw being countersunk and provided with a socket.

4. A brake device according to claim 2, wherein the locking assembly comprises at least one other hole provided on the ratchet wheel, said at least one other hole extending from the outer surface of the ratchet wheel to the inner bore thereof, and wherein the locking assembly further comprises at least one other fastener shaped and sized for inserting into said at least one other hole and securing against the overhead shaft for securing the ratchet wheel against the overhead shaft.

5. A brake device according to claim 4, wherein said at one other fastener comprises at least one setscrew.

6. A brake device according to claim 4, wherein the ratchet wheel comprises a plurality of notches, wherein the element of the pawl arm is removably insertable into one of said notches when the pawl arm is triggered into the second configuration, wherein said at least one other fastener comprises a pair of setscrews, and wherein each hole is positioned about corresponding notches on the outer surface of the ratchet wheel.

7. A brake device according to claim 6, wherein each hole is threaded for receiving a complementary threading of a corresponding fastener.

8. A brake device according to claim 1, wherein the brake device further comprises a bearing assembly configured to cooperate between the ratchet wheel and the support bracket so as to reduce possible friction thereinbetween.

9. A brake device according to claim 8, wherein the bearing assembly comprises a flange provided on a side of the ratchet wheel positionable adjacent to the support plate, and a ring made of a substantially resilient material mountable about said flange so as to act as a friction barrier between the support plate and the ratchet wheel.

10. A brake device according to claim 9, wherein the ring comprises a chamfered clip shaped and sized to be mounted about a rim of the flange of the ratchet wheel, and wherein the ring further comprises at a least one bearing surface extending substantially parallel to the flange of the ratchet wheel so as to act as a friction barrier between the support plate and said ratchet wheel.

11. A kit for assembling a brake device configured for cooperating with a counterbalancing system of a door, said counterbalancing system including a rotatable overhead shaft operatively connectable to the door for operating the same, a plug mountable about the overhead shaft and being rotatable thereabout, and a torsional spring for operatively connecting the plug to the overhead shaft and capable of being loaded thereinbetween so as to exert a torsional force for counterbalancing the weight of the door, said torsional force being transmittable between the overhead shaft and the plug via the torsional spring, the brake device being devised for blocking rotation of the overhead shaft in the event of a failure of the counterbalancing system of the door, the kit comprising:
a support bracket rigidly connectable to a fixed structure, said support bracket having a guiding arrangement;
a ratchet wheel securely mountable about the overhead shaft of the counterbalancing system, the ratchet wheel having at least one notch;
a pawl arm having first and second ends, the first end of the pawl arm being pivotably connectable to the support bracket and the second end of the pawl arm being also connectable to the support bracket for cooperating with the guiding arrangement and moving with respect to the support bracket along a given path defined by the guiding arrangement, the first and seconds ends of the pawl arm being further connectable to flanges of the plug, the pawl arm further having an element adjacent to the ratchet wheel, said element being shaped and sized to be removably insertable into said at least one notch of the ratchet wheel so as to block rotation of the ratchet wheel; and
biasing means operatively connectable between the support bracket and the pawl arm so as to exert a biasing force for biasing the pawl arm and its element towards the ratchet wheel;
wherein, when the brake device is assembled onto the counterbalancing system, the pawl arm is operable between a first configuration, corresponding to a normal operation of the counterbalancing system, where the torsional force of the torsional spring transmitted to the plug is greater than the biasing force of the biasing means acting on the pawl arm, thereby urging the pawl arm and its element away from the ratchet wheel, thus allowing the overhead shaft to rotate, and a second configuration, corresponding to a failure of the counterbalancing system, where the biasing force of the biasing means acting on the pawl arm is greater than the torsional force of the torsional spring transmitted to the plug, thereby urging the element of the pawl arm into said at least one notch of the ratchet wheel so as to block rotation of the pawl arm and thus block rotation of the overhead shaft;
the improvement wherein the kit further comprises a locking assembly configured to cooperate with the ratchet wheel so as to securely mount the same onto the overhead shaft and thus prevent the ratchet wheel from being displaced along a longitudinal axis of said overhead shaft.

12. A kit according to claim 11, wherein the locking assembly comprises at least one hole provided on the ratchet wheel, said at least one hole extending from the outer surface of the ratchet wheel to the inner bore thereof, and wherein the locking assembly further comprises at least one fastener shaped and sized for inserting into said at least one hole and for penetrating the overhead shaft for positively locking the ratchet wheel with respect to the overhead shaft and thus preventing the ratchet wheel from being displaced along the longitudinal axis of said overhead shaft.

13. A kit according to claim 12, wherein the at least one fastener comprises a screw having a head and a shaft portion, the shaft portion of the screw comprising a first portion deprived of threading, a second portion provided with threading components, and a third portion provided with self-drilling components, the head of the screw being countersunk and provided with a socket.

14. A kit according to claim 13, wherein the locking assembly comprises at least one other hole provided on the ratchet wheel, said at least one other hole extending from the outer surface of the ratchet wheel to the inner bore thereof, and wherein the locking assembly further comprises at least one other fastener shaped and sized for inserting into said at least one other hole and securing against the overhead shaft for securing the ratchet wheel against the overhead shaft.

15. A kit according to claim 14, wherein the ratchet wheel comprises a plurality of notches, and wherein the element of the pawl arm is removably insertable into one of said notches when the pawl arm is triggered into the second configuration, wherein said at least one other fastener comprises a pair of setscrews, wherein each hole is positioned about corresponding notches on the outer surface of the ratchet wheel, and wherein each hole is threaded for receiving a complementary threading of a corresponding fastener.

16. A kit according to claim 11, wherein the kit further comprises a bearing assembly configured to cooperate between the ratchet wheel and the support bracket so as to reduce possible friction thereinbetween.

17. A kit according to claim 16, wherein the bearing assembly comprises a flange provided on a side of the ratchet wheel positionable adjacent to the support plate, and a ring made of a substantially resilient material mountable about said flange so as to act as a friction barrier between the support plate and the ratchet wheel, the ring comprising a chamfered clip shaped and sized to be mounted about a rim of the flange of the ratchet wheel, and the ring further comprising at a least one bearing surface extending substantially parallel to the flange of the ratchet wheel so as to act as a friction barrier between the support plate and said ratchet wheel.

18. A kit according to claim 11, wherein the biasing means comprise a loaded spring member having a first end connectable to the support bracket and a second end restable against the pawl arm.

19. A kit according to claim 11, wherein the pawl arm is arc-shaped, wherein the first and second ends of the pawl arm are diametrically opposed to one another, wherein the guiding arrangement of the support bracket comprises a guiding slot acting as the given path, and wherein the kit comprises fasteners for connecting the first and second ends of the pawl arm to the flanges of the plug, one of said fasteners being mountable onto the second end of the pawl arm so as to cooperate with the guiding slot of the support bracket and allow the second end of the pawl arm to move along said guiding slot of the support bracket.

20. A door assembly comprising a counterbalancing system including a rotatable overhead shaft operatively connectable to the door assembly for operating the same, a plug mountable about the overhead shaft and being rotatable thereabout, and a torsional spring for operatively connecting the plug to the overhead shaft and capable of being loaded thereinbetween so as to exert a torsional force for counterbalancing the weight of the door assembly, said torsional force being transmittable between the overhead shaft and the plug via the torsional spring, the door assembly further comprising a brake device configured for cooperating with the counterbalancing system and being devised for blocking rotation of the overhead shaft in the event of a failure of the counterbalancing system of the door assembly, the brake device comprising:
a support bracket rigidly connectable to a fixed structure, said support bracket having a guiding arrangement;
a ratchet wheel having an outer surface and an inner bore securely mountable about the overhead shaft of the counterbalancing system, the outer surface of the ratchet wheel having at least one notch;
a pawl arm having first and second ends, the first end of the pawl arm being pivotably connectable to the support bracket and the second end of the pawl arm cooperating with the guiding arrangement and being movable with respect to the support bracket along a given path defined by the guiding arrangement, the first and seconds ends of the pawl arm being further connectable to flanges of the plug on either side of the overhead shaft, the pawl arm further having an element adjacent to the ratchet wheel, said element being shaped and sized to be removably insertable into said at least one notch of the ratchet wheel so as to block rotation of the ratchet wheel; and
biasing means operatively connected between the support bracket and the pawl arm so as to exert a biasing force for biasing the pawl arm and its element towards the ratchet wheel;
wherein the pawl arm is operable between a first configuration, corresponding to a normal operation of the counterbalancing system, where the torsional force of the torsional spring transmitted to the plug is greater than the biasing force of the biasing means acting on the pawl arm, thereby urging the pawl arm and its element away from the ratchet wheel, thus allowing the overhead shaft to rotate, and a second configuration, corresponding to a failure of the counterbalancing system, where the biasing force of the biasing means acting on the pawl arm is greater than the torsional force of the torsional spring transmitted to the plug, thereby urging the element of the pawl arm into said at least one notch of the ratchet wheel so as to block rotation of the pawl arm and thus block rotation of the overhead shaft;
the improvement wherein the brake device further comprises a locking assembly configured to cooperate with the ratchet wheel so as to securely mount the same onto the overhead shaft and thus prevent the ratchet wheel from being displaced along a longitudinal axis of said overhead shaft.
